(19) United States
(12) Patent Application Publication
(10) Pub. No.: US 2026/0361799 A1
(43) Pub. Date: Nov. 12, 2026

(54) SYSTEMS AND METHODS FOR INTELLIGENT API CACHING

(71) Applicant: VERIZON PATENT AND LICENSING INC., Basking Ridge, NJ (US)

(72) Inventors: Vasanth VARMA, Hyderabad (IN); Rohit AGRAWAL, Hyderabad (IN); Sudheer TATAPUDI, Hyderabad (IN); Kanakasubramaniam KRISHNAMURTHI, Chennai (IN); Ravindra Babu TIRUPAPULA, Hyderabad (IN); Sivapragash KRISHNAN, Chennai (IN); Suresh GUNDAPANENI, Hyderabad (IN); Rameshkumar DURAISAMY, Coimbatore (IN); Sasidhar Venkata NAGA, Hyderabad (IN); Madhvi LALANKUMAR, Hyderabad (IN)

(73) Assignee: VERIZON PATENT AND LICENSING INC., Basking Ridge, NJ (US)

(21) Appl. No.: 19/202,102

(22) Filed: May 8, 2025

(51) Int. Cl. H04L 67/568; H04L 41/0631

(52) U.S. Cl. CPC H04L 67/568; H04L 41/0631

(57) ABSTRACT

Disclosed are systems and methods that provide an intelligent cache management framework for multi-layer industry-level systems. The disclosed framework functions by automatically identifying, implementing, and maintaining caching mechanisms for appropriate services and APIs to enhance overall system responsiveness. In some implementations, the framework analyzes various information sources to recommend ideal candidate entities for caching, then automatically enables caching for these APIs, thereby reducing response times for clients. The framework can incorporate self-healing functionality that activates when issues with cached APIs are detected, seamlessly redirecting traffic to actual API calls to maintain system integrity and performance.

### BACKGROUND INFORMATION

Smart entity caching refers to an intelligent, often context-aware strategy with autonomous identification of cacheable data (or entities) for storing and retrieving the same, that can improve performance, reduce redundant computation, and optimize resource usage in software systems. Such mechanisms can be utilized in distributed systems, semantic engines, artificial intelligence (AI) platforms, and smart home environments, and the like.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is block diagram of an example network architecture according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates a non-limiting example embodiment of a network architecture according to some embodiments of the present disclosure; and

FIG. 5 is a block diagram illustrating a computing device showing an example of a client or server device used in various embodiments of the present disclosure.

### DETAILED DESCRIPTION OF EXAMPLE EMBODIMENTS

According to some embodiments, as discussed herein, the disclosed systems and methods provide a framework that can be implemented in multi-layered solution architectures, featuring one to multiple layers, with each layer capable of incorporating a caching solution to enhance the transaction performance. The disclosed framework can function to capture numerous observatory aspects associated with applications, such as logs and metrics. The framework can include a cache candidate recommendation utility that analyzes these observatory aspects, including logs, New Relic data, and other system-generated information, to identify potential cacheable candidates within the application environment. The disclosed utility mechanism can process the collected data while also considering custom-defined rules, which can encompass specifications such as, but not limited to, payload consistency for electronic transactions over specified timeframes (hours, days, or months). Based on these rules and live data observations from the monitoring tools, the framework can generate recommendations regarding which Application Program Interfaces (APIs) and/or entities are suitable caching candidates for the application.

In some embodiments, the framework can extend beyond mere recommendation to include autonomous management capabilities, enabling a self-sustaining operational model that eliminates the need for manual intervention in the configuration process. In some embodiments, the disclosed cache candidate management utility can function to examine the same observatory data sources, applying custom rules, and leveraging contextual intelligence to determine cacheable APIs. In some embodiments, the framework can automatically configure identified candidates without requiring human oversight. The management framework can operate as a self-running program that continuously monitors various data points, identifies caching opportunities, and implements the necessary configurations autonomously. Such automation streamlines the process and significantly reduces the resource expenditure and administrative burden on system operators.

In some embodiments, the framework can incorporate adaptive monitoring capabilities that observe system performance after caching implementation. For example, in some embodiments, if the framework detects any issues or performance degradation following the caching of particular APIs, the framework can function, cause and/or trigger operations that can automatically disable the caching for those specific components, effectively implementing an auto-remediation mechanism. Such continuous evaluation process recognizes that caching candidates deemed suitable at one point can become inappropriate over time due to changing conditions or requirements. The storage management framework addresses this temporal variability by constantly observing data patterns and dynamically adjusting caching configurations as needed. Rather than relying on expert intervention for manual corrections, the framework self-corrects by identifying APIs that are no longer suitable for caching and removing them from the caching configuration automatically.

In some embodiments, the framework can maintain optimal system performance through this iterative approach to caching management, where the framework continuously learns from operational data and refines its caching strategy accordingly. This adaptive methodology ensures that the caching implementation remains aligned with current system behaviors and requirements, even as the underlying applications and usage patterns evolve over time. Indeed, the framework's ability to detect changes in API suitability for caching and automatically update configurations represents a significant advancement over traditional static caching implementations that require periodic manual reviews and adjustments. By autonomously managing the full lifecycle of cached APIs (e.g., from identification through implementation to potential decommissioning), the framework delivers substantial operational efficiencies while maintaining optimal system performance.

In some embodiments, the framework can leverage the observatory aspects of the system to build a comprehensive understanding of transaction patterns and behaviors. Such observatory aspects serve as the foundation for identifying caching opportunities, providing rich contextual information about how applications interact with data and how users interact with applications. The framework's ability to process and analyze these observatory aspects enables it to make intelligent decisions about which components should be cached, considering factors such as, but not limited to, access frequency, computational cost, data volatility, and transaction similarity. Such data-driven approach ensures that caching decisions are based on actual system behavior rather than theoretical assumptions or static rules.

In some embodiments, the framework can integrate with existing monitoring infrastructure, such as logging systems and application performance monitoring tools, to gather the necessary data for making caching decisions. This integration allows the framework to leverage investments in monitoring infrastructure that organizations have already made, reducing the need for additional data collection mechanisms. By tapping into these established data sources, the framework can quickly begin identifying caching opportunities without requiring extensive new instrumentation of applications or services.

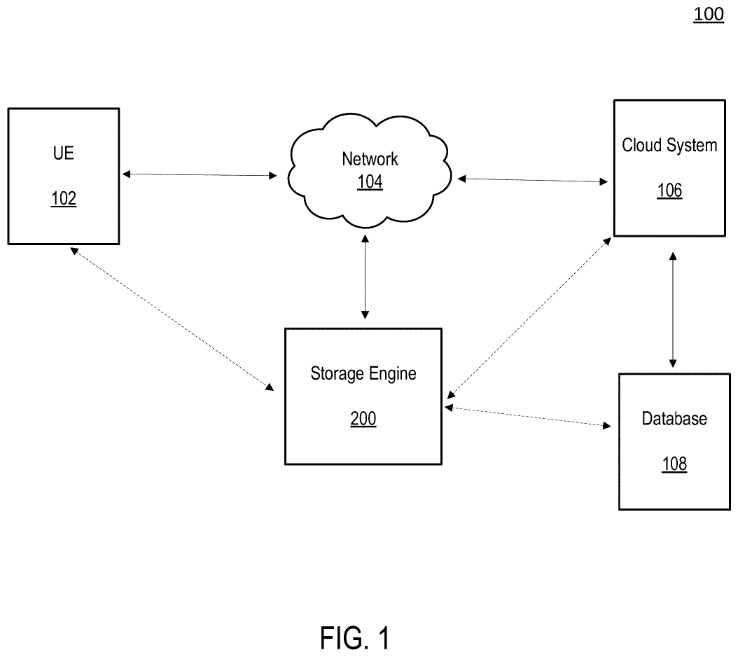

With reference to FIG. 1, system 100 is depicted which includes user equipment (UE) 102, network 104, cloud system 106, database 108, and storage engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1.

According to some embodiments, UE 102 can be any type of device operated in a mobile wireless network. For example, UE 102 can include, but not be limited to, a mobile phone, tablet, laptop, Internet of Things (IoT) device, wearable device, an autonomous guided vehicle (AGV), autonomous mobile robot (AMR), unmanned aerial vehicle (UAV), and/or any other type of device.

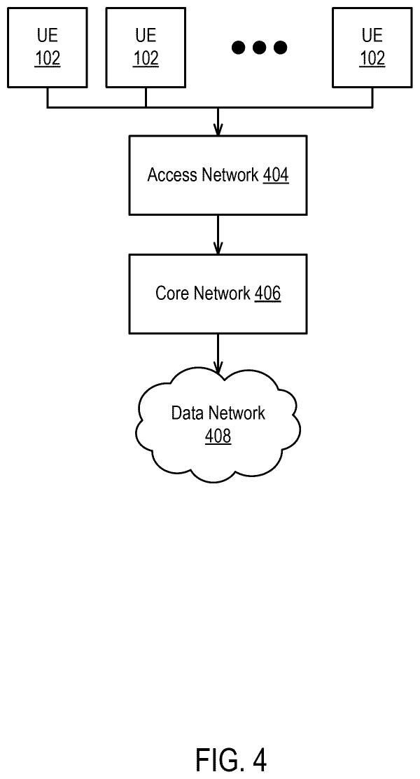

In some embodiments, network 104 can be any type of network, and can facilitate connectivity of the components of system 100, as illustrated in FIG. 1. Further discussion of embodiments of network 104 are provided below with reference to FIG. 4.

According to some embodiments, cloud system 106 can be any type of cloud operating platform and/or network-based system upon which applications, operations, and/or other forms of network resources can be located. For example, cloud system 106 can be a service provider and/or network provider from where services and/or applications can be accessed, sourced or executed from. For example, system 106 can represent the cloud-based infrastructure associated with a Mobile Network Operator (MNO) or the tenant of a dedicated network (e.g., network 104), and communicates with associated network resources hosted in a private or neutral host network (e.g., network 104).

In some embodiments, cloud system 106 can include a server(s) and/or a database of information. In some embodiments, a database 108 of cloud system 106 can store a set of data and/or metadata associated with network information related to the components and/or the users (e.g., UEs 102) of system 100. In addition, database 108 can store information (e.g., video content, embeddings, similarity metrics, LLMs, and the like) used by a storage engine 200, which corresponds to the novel functionality described herein.

In some embodiments, cloud system 106 can provide a private/proprietary management platform for network 104 and other devices/platforms operating thereon, and further host and/or communicate with storage engine 200.

According to some embodiments, database 108 can correspond to a data storage for a platform (e.g., a network hosted platform, such as cloud system 106) or a plurality of platforms. Database 108 can receive storage instructions/requests from, for example, storage engine 200 (and associated microservices), which can be in any type of known or to be known format, such as, for example, standard query language (SQL). Database 108 can correspond to any type of known or to be known storage, for example, a memory or memory stack of a device, a distributed ledger of a distributed network (e.g., blockchain, for example), a look-up table (LUT), and/or any other type of secure data repository.

Storage engine 200, as discussed above and further below in more detail, can include components for the disclosed functionality. According to some embodiments, storage engine 200 can be a special-purpose machine or processor within cloud system 106, or hosted by a device (or component) on network 104. In some embodiments, storage engine 200 can be hosted by a server and/or set of servers associated with cloud system 106.

According to some embodiments, storage engine 200 can be configured to implement and/or control a plurality of services and/or microservices, where each of the plurality of services/microservices are configured to execute a plurality of workflows associated with performing the disclosed estimation of backhaul bandwidth and private core capacity. Non-limiting embodiments of such workflows are provided below.

According to some embodiments, storage engine 200 can function as an application provided by and/or hosted on network 104 (e.g., any UE and/or node as discussed below in relation to FIG. 1B) and/or by cloud system 106. In some embodiments, storage engine 200 can be embodied as an application executing on UE 102 (e.g., downloaded and/or web-based execution, for example). In some embodiments, storage engine 200 can function as an application installed on a server(s), network location and/or other type of network resource associated with cloud system 106 and/or network 104. In some embodiments, storage engine 200 can be configured and/or installed as an augmenting script, program or application (e.g., a plug-in or extension) to another application or program provided by cloud system 106 and/or network 104 that is executed over network 104 and/or on UE 102.

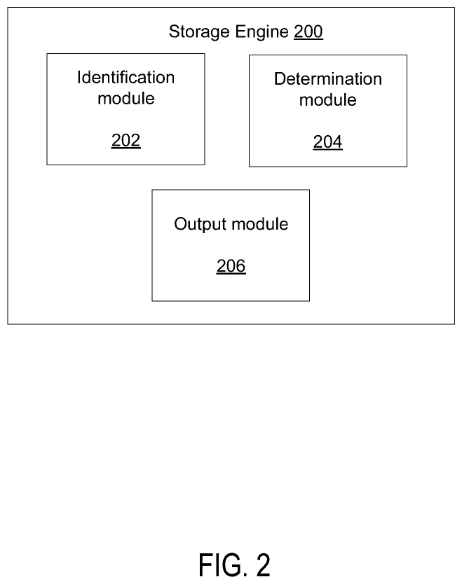

As illustrated in FIG. 2, according to some embodiments, storage engine 200 includes identification module 202, determination module 204 and output module 206. It should be understood that the modules discussed herein are non-exhaustive, as additional or fewer modules (or sub-modules) can be applicable to the embodiments of the systems and methods discussed. More detail of the operations, configurations and functionalities of storage engine 200 and each of its modules, and their role within embodiments of the present disclosure will be discussed below.

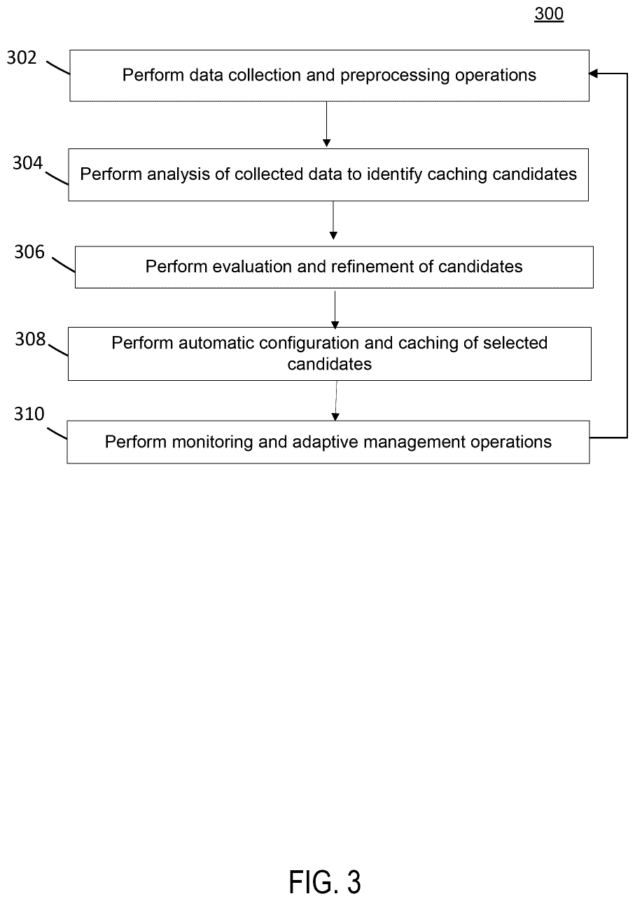

In FIG. 3, Process 300 provides non-limiting example embodiments for an intelligent cache management framework in multi-layer industry-level systems. The disclosed framework functions by automatically identifying, implementing, and maintaining caching mechanisms for appropriate services and APIs to enhance overall system responsiveness. In some embodiments, as discussed herein, the framework analyzes various information sources to recommend ideal candidate entities for caching, then automatically enables caching for these APIs, thereby reducing response times for clients. Additionally, the framework can incorporate self-healing functionality that activates when issues with cached APIs are detected, seamlessly redirecting traffic to actual API calls to maintain system integrity and performance.

In some embodiments, the framework can deliver an automated solution that examines historical and/or real-time API data collected from diverse sources, including application logs (such as Elasticsearch and OpenSearch), observability platforms (like New Relic), and application performance monitoring systems. Such comprehensive data collection enables the framework to evaluate each API's suitability for caching based on predefined parameters or templates that reflect optimal caching conditions. Once the framework identifies appropriate caching candidates, the framework can independently configure such APIs for caching implementation without requiring manual intervention. Simultaneously, in some embodiments, the framework establishes a monitoring routine specifically designed to detect any issues that might arise as a consequence of the caching implementation. Such monitoring can incorporate information from project management and issue tracking tools to capture any functional or performance problems reported by users or detected by system monitoring.

In some embodiments, the framework can implement a monitoring phase during which it continuously evaluates the performance and behavior of cached APIs. For example, if/when the framework identifies any issues related to cached content, the framework can automatically revert the caching configuration and place the affected API into a designated reanalysis stack. This stack serves as a controlled environment where a specialized routine can thoroughly analyze the API's behavior patterns, identifying the specific conditions or characteristics that led to the caching-related issues. Based on this analysis, the framework can make automatic adjustments to the caching parameters and potentially re-enable the API for caching with these optimized settings. This adaptive approach ensures that the system maintains optimal performance while minimizing the risk of persistent issues related to inappropriate caching implementations.

In some embodiments, the framework can maintain long-running routines specifically designed to identify changes in cached APIs and implement necessary adjustments accordingly. This continuous monitoring capability enables the framework to adapt to evolving API behaviors, changing usage patterns, or modifications to the underlying API implementation. By detecting these changes and responding with appropriate caching configuration updates, the framework ensures that the caching strategy remains effective and appropriate even as the system evolves over time. This proactive approach to cache management significantly reduces the need for manual intervention and helps prevent potential performance degradation that might otherwise occur when cached APIs undergo changes that affect their caching suitability.

In some embodiments, the framework can leverage artificial intelligence and/or machine learning (AI/ML) models/algorithms by feeding data collected from its various monitoring routines into an AI/ML model. This integration of AI/ML capabilities enhances the framework's decision-making processes over time, as the AI/ML component gradually assumes responsibility for various determinations regarding caching suitability, configuration parameters, and adjustment strategies. As such AI/ML model(s) develops through continuous learning, the framework becomes increasingly streamlined, with the AI/ML components making increasingly complex and accurate decisions about which APIs to cache, how to configure caching parameters, and when to implement adjustments in response to detected issues or changes. Such AI/ML involvement and decision-making represents a significant advancement over conventional automated cache management systems, moving beyond rule-based approaches to more nuanced, context-aware determinations.

In some embodiments, as discussed herein, the framework can be implemented in two distinct phases, beginning with the Cache Candidate Recommendation functionality. This initial phase focuses exclusively on identifying and recommending cacheable candidate APIs based on comprehensive data analysis. The framework collects relevant information from observatory platforms, analyzes this data according to established caching criteria, and incorporates any custom rules or business requirements that might affect caching decisions. Based on this analysis, the framework generates recommendations identifying which APIs are suitable for caching, allowing users to configure their caching systems accordingly. This recommendation-focused approach provides valuable guidance while still maintaining human oversight of the actual implementation process.

In some embodiments, the framework can extend beyond recommendations through its Cache Candidate Management functionality, which represents a more comprehensive and autonomous approach to cache management. This advanced phase acknowledges the inherent complexity of cache invalidation—a notoriously challenging aspect of any caching system. In real-world environments, continuous monitoring of application behavior after implementing caching is essential to ensure that functionally correct data continues to be rendered by the application. This monitoring often involves tracking defects related to data integrity or consistency issues that might arise from improper or outdated caching. The management functionality builds upon the recommendation capabilities by automatically configuring the system to cache approved candidate APIs and then actively monitoring their performance and impact on application behavior.

According to some embodiments, Step 302 of Process 300 can be performed by identification module 202 of storage engine 200; Steps 304 and 306 can be performed by determination module 204; and Steps 308 and 310 can be performed by output module 206.

According to some embodiments, Process 300 can begin with Step 302, where engine 200 can perform data collection and preprocessing operations. According to some embodiments, Step 302 can involve engine 200 systematically gathering, retrieving, identifying, extracting, determining, downloading, requesting or otherwise identifying information from various observatory sources including, but not limited to, application logs stored in clusters, such as Elasticsearch or OpenSearch clusters, for example, performance metrics captured by monitoring tools, like New Relic, and the like, for example, transaction data from application performance monitoring (APM) systems, and the like, or some combination thereof. In some embodiments, such data collection operation can encompass historical information spanning predefined time periods (e.g., about past 30 days) and/or real-time streaming data to ensure comprehensive coverage of API behavior patterns.

In some embodiments, engine 200 can employ data normalization techniques to standardize information from disparate sources, ensuring consistent analysis despite differences in data formats or structures. Additionally, engine 200 can perform preliminary filtering to exclude irrelevant data points, thereby focusing subsequent analysis on meaningful information that accurately represents API characteristics and usage patterns.

In Step 304, engine 200 can perform detailed analysis of the collected data to determine potential caching candidates. This analysis operation begins with pattern recognition algorithms that identify repetitive API response patterns, examining payload consistency across multiple invocations of the same API endpoint. In some embodiments, engine 200 can function to calculate frequency metrics for each API, determining how often they are called within specific timeframes and identifying high-volume endpoints that might benefit most from caching. Response time analysis identifies APIs with consistently long execution times that could be accelerated through caching, while payload size assessment evaluates the memory implications of caching particular responses. Data volatility assessment determines how frequently the response data changes, with stable responses being more suitable for caching than highly dynamic ones. In some embodiments, engine 200 can conduct dependency mapping to understand interconnections between APIs, identifying scenarios where caching one API might benefit multiple dependent services downstream. In some embodiments, such comprehensive analysis can result in a scoring operation that assigns a “cacheability score” to each API based on weighted combinations of these factors.

In some embodiments, Step 304's analysis and determinations can involve or be based on engine 200 utilizing one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the network data, as discussed herein.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination with any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

In Step 306, which represents the rule-based evaluation and refinement of caching candidates. During this operation, engine 200 can apply predefined and/or dynamically determined rules and constraints to the potential caching candidates identified in Step 304, discussed supra. In some embodiments, Step 306 can involve implementing AI/ML models similar to those discussed above in Step 304.

According to some embodiments, the applied rules (e.g., executable data structures defined in Step 304) can include restrictions based on data sensitivity (e.g., excluding APIs that return personally identifiable information), compliance requirements (avoiding caching regulated data), business criticality (providing special handling for revenue-critical transactions), and the like, or some combination thereof. In some embodiments, engine 200 can function to evaluate each API against custom templates that define ideal caching scenarios for particular types of services or data patterns. Engine 200 can then perform impact analysis to predict potential performance improvements from caching, calculating estimated response time reductions and resource utilization benefits. In some embodiments, engine 200 can execute a validation operation that confirms that proposed caching candidates meet all technical requirements for effective caching, including having deterministic responses for given inputs and appropriate authentication mechanisms. In some embodiments, engine 200 can perform such analysis and determinations based on factors such as, but not limited to, time-of-day usage patterns, user demographics, geographic distribution, and the like, which can weight or influence caching decisions.

In Step 308, engine 200 can function to perform or cause automatic configuration and implementation of caching of approved/selected candidates for the APIs. In some embodiments, Step 308 involves engine 200 performing a prioritization operation that ranks approved caching candidates based on potential impact, technical feasibility, and business value to determine implementation order. Engine 200 then proceeds with cache strategy selection, selecting appropriate caching mechanisms (e.g., in-memory, distributed cache, CDN) based on API characteristics and performance requirements. Engine 200 then performs time-to-live (TTL) calculation to determine optimal cache expiration periods for each API, balancing performance gains against data freshness requirements.

According to some embodiments, such configuration operations can automatically generate and deploy necessary caching configurations, including, but not limited to, cache key definitions that uniquely identify cacheable responses, serialization formats for stored data, and compression settings to optimize storage efficiency. In some embodiments, the implementation of cache tagging and versioning mechanisms can facilitate selective invalidation when upstream data changes. Accordingly, in some embodiments, engine 200 can implement monitoring hooks during configuration to track cache performance metrics and detect potential issues. In some embodiments, engine 200 can implement a gradual rollout strategy, potentially starting with a threshold percentage of traffic directed to cached responses while monitoring for any issues before full implementation.

In some embodiments, Step 308 can involve execution of configuration optimizations that are designed to maximize caching effectiveness while minimizing potential issues. In some embodiments, such operations can include implementing partial response caching for APIs that return partially static data, extracting and caching only the stable portions while dynamically generating variable elements. In some embodiments, engine 200 can function to create hierarchies that store frequently accessed data in faster, memory-based caches while relegating less-common responses to slower but more capacious storage tiers. Engine 200 can implement stale-while-revalidate mechanisms that serve cached content while simultaneously refreshing it in the background, providing optimal response times without compromising data freshness. The configuration operation also establishes cache warming procedures that proactively populate caches with high-value responses before peak usage periods, preventing performance degradation during high-demand intervals. For APIs with personalized but largely similar responses across users, engine 200 can function to implement cache variations that store response templates with personalized elements injected at request time, maximizing cache efficiency while maintaining response customization.

In Step 310, engine 200 can perform continuous monitoring and adaptive management of the caching implementation. In some embodiments, Step 310 can involve implementation of performance tracking operations that continuously (or periodically according to a criteria (e.g., time, event type, metric values, and the like) measure key metrics including, but not limited to, cache hit rates (percentage of requests served from cache), response time improvements compared to pre-caching baselines, system resource utilization changes resulting from caching, and the like, and/or some combination thereof.

In some embodiments, engine 200 can implement error detection mechanisms that actively identify anomalies in cached responses, and compare them with updated or current (e.g., “fresh”) data samples to detect inconsistencies or outdated information. Engine 200 can implement issue correlation by connecting reported defects from tracking systems, such as, for example, JIRA, with specific cached APIs to identify potential relationships between caching and functional problems. In some embodiments, engine 200 can implement health check operations to validate cached responses against fresh data to ensure continued accuracy and appropriateness. Accordingly, when issues are detected, engine 200 can initiate automated remediation procedures, beginning with targeted cache invalidation for problematic entries and potentially escalating to completely disabling caching for specific APIs if/when necessary. Such monitoring mechanisms can cause, output and/or maintain a comprehensive audit trail documenting all caching decisions, modifications, and incidents to support troubleshooting and compliance requirements.

In some embodiments, Step 310 can involve advanced adaptive management operations. Such operations can involve implementing, for example, A/B testing mechanisms to compare different caching strategies for the same API, allowing data-driven optimization of caching parameters. In some embodiments, engine 200 can conduct periodic reassessment of caching configurations, automatically adjusting TTL values based on observed data change frequencies and access patterns. In some embodiments, engine 200 can identify edge cases where cached responses can be inappropriate for certain user segments or transaction types, implementing conditional caching rules accordingly. The monitoring mechanisms can also track system-wide cache utilization to prevent memory overuse, implementing automatic eviction policies for less valuable cached data when storage constraints arise.

In some embodiments, engine 200 can compile and monitor/maintain a reanalysis queue data structure or file for APIs that experienced caching-related issues, subjecting them to deeper analysis to identify root causes and potential solutions before attempting to re-enable caching with modified parameters. Such continuous feedback loop ensures that the caching strategy evolves alongside changing application behavior and requirements.

In some embodiments, the framework can incorporate learning mechanisms within Step 310 that continuously improve caching decisions based on operational experience. The framework records response patterns over time to detect seasonal or periodic variations that might require dynamic adjustments to caching strategies. The framework can function to build knowledge bases of caching outcomes, documenting successful and problematic scenarios to inform future decisions. Pattern recognition algorithms identify changing usage trends that might affect caching suitability, such as shifts in access frequency or payload consistency. The monitoring mechanisms discussed herein can employ predictive analytics to anticipate potential caching issues before they impact users, taking preemptive action to adjust configurations accordingly. As the framework processes more operational data, it progressively refines its understanding of optimal caching conditions for specific API types and usage patterns, resulting in increasingly sophisticated and effective recommendations over time.

In some embodiments, the framework can incorporate comprehensive reporting and visualization capabilities that span the entire process from Steps 302-310, providing stakeholders with actionable insights into caching operations and benefits. These capabilities include real-time dashboards displaying current cache performance metrics, including hit rates, response time improvements, and resource utilization changes. Historical trend analysis visualizes caching effectiveness over time, highlighting patterns and potentially problematic areas requiring attention. The reporting system provides return on investment (ROI) calculations quantifying infrastructure cost savings and user experience improvements resulting from implemented caching strategies. API-specific reports detail individual endpoint performance before and after caching implementation, with granular metrics supporting targeted optimization. The visualization components include topology maps showing cache distribution across system layers and the relationships between cached APIs and dependent services. Exception reports highlight APIs that were flagged as potential caching candidates but excluded due to specific rules or constraints, providing transparency into the decision-making process. Such comprehensive reporting framework ensures that both technical and business stakeholders can understand, evaluate, and optimize the caching implementation based on concrete metrics and clear visualizations.

In some embodiments, the framework can implement security and compliance safeguards throughout Steps 302-310 to ensure that caching operations meet organizational and regulatory requirements. These safeguards include data classification mechanisms that automatically identify sensitive information within API responses and apply appropriate caching restrictions. The framework enforces encryption for cached data containing sensitive information, ensuring protection at rest and in transit. Access control mechanisms restrict cache access to authorized services and users, preventing potential data leakage through cache inspection. The framework implements configurable retention policies that automatically purge cached data after specified periods to comply with data minimization requirements. Audit logging records cache access events, supporting compliance reporting and security investigations. The framework can also perform regular compliance validation checks to ensure that caching configurations remain aligned with organizational policies and regulatory requirements as they evolve over time. By integrating these security considerations throughout the caching lifecycle, the framework ensures that performance optimizations do not compromise data protection or compliance obligations.

FIG. 4 is a block diagram of an example network architecture according to some embodiments of the present disclosure. In the illustrated embodiment, UE 102 accesses a data network 408 via an access network 404 and a core network 406.

In the illustrated embodiment, the access network 404 comprises a network allowing network communication with UE 102. In general, the access network 404 includes at least one base station that is communicatively coupled to the core network 406 and coupled to zero or more UE 102.

In some embodiments, the access network 404 comprises a cellular access network, for example, a 5G network. In an embodiment, the access network 404 can include a NextGen Radio Access Network (NG-RAN). In an embodiment, the access network 404 includes a plurality of next Generation Node B (e.g., eNodeB and gNodeB) base stations connected to UE 102 via an air interface. In one embodiment, the air interface comprises a New Radio (NR) air interface. For example, in a 4G network, individual user devices can be communicatively coupled via an X2 interface.

In the illustrated embodiment, the access network 404 provides access to a core network 406 to UE 102. In the illustrated embodiment, the core network can be owned and/or operated by a network operator (NO) and provides wireless connectivity to UE 102. In the illustrated embodiment, this connectivity can comprise voice and data services.

At a high-level, the core network 406 can include a user plane and a control plane. In one embodiment, the control plane comprises network elements and communications interfaces to allow for the management of user connections and sessions. By contrast, the user plane can comprise network elements and communications interfaces to transmit user data from UE 102 to elements of the core network 406 and to external network-attached elements in a data network 408 such as the Internet.

In the illustrated embodiment, the access network 404 and the core network 406 are operated by a NO. However, in some embodiments, the networks (404, 406) can be operated by a private entity and can be closed to public traffic. For example, the components of the network 406 can be provided as a single device, and the access network 404 can comprise a small form-factor base station. In these embodiments, the operator of the device can simulate a cellular network, and UE 102 can connect to this network similar to connecting to a national or regional network.

In some embodiments, the access network 404, core network 406 and data network 408 can be configured as a MEC network, where MEC or edge nodes are embodied as each UE 102 and are situated at the edge of a cellular network, for example, in a cellular base station or equivalent location. In general, the MEC or edge nodes can comprise UEs that comprise any computing device capable of responding to network requests from another UE 102 (referred to generally for example as a client) and is not intended to be limited to a specific hardware or software configuration of a device.

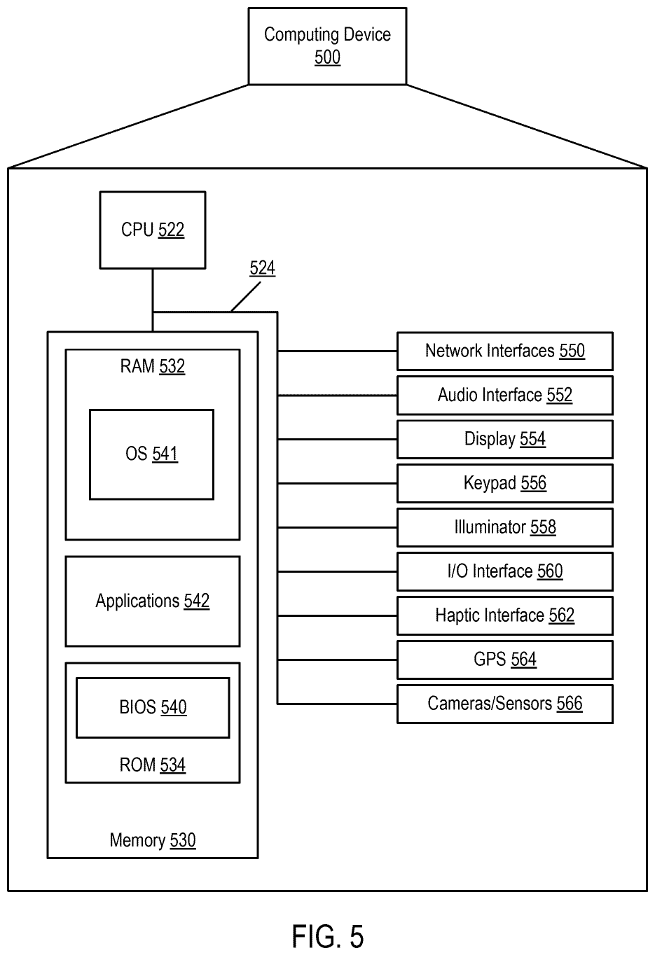

FIG. 5 is a block diagram illustrating a computing device showing an example of a client or server device used in the various embodiments of the disclosure.

The computing device 500 can include more or fewer components than those shown in FIG. 5, depending on the deployment or usage of the device 500. For example, a server computing device, such as a rack-mounted server, cannot include audio interfaces 552, displays 554, keypads 556, illuminators 558, haptic interfaces 562, GPS receivers 564, or cameras/sensors 566. Some devices can include additional components not shown, such as graphics processing unit (GPU) devices, cryptographic co-processors, artificial intelligence (AI) accelerators, or other peripheral devices.

As shown in FIG. 5, the device 500 includes a CPU 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 can comprise a general-purpose CPU. The CPU 522 can comprise a single-core or multiple-core CPU. The CPU 522 can comprise a system-on-a-chip (SoC) or a similar embedded system. In some embodiments, a GPU can be used in place of, or in combination with, a CPU 522. Mass memory 530 can comprise a dynamic random-access memory (DRAM) device, a static random-access memory device (SRAM), or a Flash (e.g., NAND Flash) memory device. In some embodiments, mass memory 530 can comprise a combination of such memory types. In one embodiment, the bus 524 can comprise a Peripheral Component Interconnect Express (PCIe) bus. In some embodiments, the bus 524 can comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) 540 for controlling the low-level operation of the computing device 500. The mass memory also stores an operating system 541 for controlling the operation of the computing device 500.

Applications 542 can include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 can then read the software or data from RAM 532, process them, and store them to ROM 534.

The computing device 500 can optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 can be coupled to a speaker and microphone (not shown) to enable telecommunication with others or generate an audio acknowledgment for some action. Display 554 can be a liquid crystal display (LCD), gas plasma, light-emitting diode (LED), or any other type of display used with a computing device. Display 554 can also include a touch-sensitive screen arranged to receive input from an object such as a stylus or a digit from a human hand.

Keypad 556 can comprise any input device arranged to receive input from a user. Illuminator 558 can provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 can communicate through other components, providing other information that can be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter can, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter can be embodied as methods, devices, components, or systems. Accordingly, embodiments can, for example, take the form of hardware, software, firmware or any combination thereof (other than software per se). The following detailed description is, therefore, not intended to be taken in a limiting sense.

Throughout the specification and claims, terms can have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology can be understood at least in part from usage in context. For example, terms, such as “and”, “or”, or “and/or,” as used herein can include a variety of meanings that can depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special-purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium can comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes can be made thereto, and additional embodiments can be implemented without departing from the broader scope of the disclosed embodiments as set forth in the claims that follow. The specification and drawings are accordingly to be regarded in an illustrative rather than restrictive sense.

What is claimed is:

1. A method comprising:
identifying data associated with a set of sources, the data corresponding to behavior of an application program interface (API) associated with a respective source;
analyzing the data, and determining a set of caching candidates for each API;
analyzing the set of caching candidates, and determining, for each API, a selected caching candidate from the set of caching candidates, each selected caching candidate comprising functionality related to a service of a respective API;
causing automatic configuration and execution of caching implementations for each API based on the selected caching candidate for each API.

2. The method of claim 1, further comprising:
monitoring performance of the caching implementations for each API;
determining, based on the monitored performance, information related to an accuracy and appropriateness of each respective caching implementation; and
updating a caching implementation for a respective API when the determined information indicates an adaption to the caching implementation is required.

3. The method of claim 2, the monitoring comprising:
tracking cache hit rates, response time improvements, and system resource utilization changes;
comparing cached responses with updated data samples to detect inconsistencies or outdated information; and
correlating reported defects from issue tracking with specific cached APIs to identify relationships between caching and functional problems.

4. The method of claim 2, further comprising the determined information corresponding to the service of a respective API, detected defects and changing system behavior.

5. The method of claim 1, further comprising:
ranking the caching candidates based on information comprising at least one of consistency, access frequency, response time or payload size; and
performing the selection of each caching candidate based on the service of a respective API and the ranking.

6. The method of claim 1, further comprising the service of each API corresponding to API characteristics and performance requirements.

7. The method of claim 1, further comprising:
implementing cache tagging and versioning mechanisms to facilitate selective invalidation when upstream data changes; and
establishing a gradual rollout strategy starting with a threshold percentage of traffic directed to cached responses before full implementation of the selected caching implementations.

8. The method of claim 1, further comprising:
maintaining a reanalysis queue for APIs that experience caching-related issues;
subjecting APIs in the reanalysis queue to analysis to identify root causes of caching problems; and
re-enabling caching with modified parameters for APIs that have been analyzed and remediated.

9. The method of claim 1, further comprising the set of sources comprising at least one of an application log, performance monitoring tool, or application performance management (APM) tool, the data comprising at least one of historical information or real-time information for a respective API of each source.

10. The method of claim 1, further comprising the data comprising information related to at least one of response patterns, call frequency, response times, payload sizes, data volatility, or dependency relationships.

11. A system comprising:
a processor configured to:
identify data associated with a set of sources, the data corresponding to behavior of an application program interface (API) associated with a respective source;
analyze the data, and determine a set of caching candidates for each API;
analyze the set of caching candidates, and determine, for each API, a selected caching candidate from the set of caching candidates, each selected caching candidate comprising functionality related to a service of a respective API; and
cause automatic configuration and execution of caching implementations for each API based on the selected caching candidate for each API.

12. The system of claim 11, wherein the processor is further configured to:
monitor performance of the caching implementations for each API;
determine, based on the monitored performance, information related to an accuracy and appropriateness of each respective caching implementation; and
update a caching implementation for a respective API when the determined information indicates an adaption to the caching implementation is required.

13. The system of claim 12, wherein the processor is further configured to:
track cache hit rates, response time improvements, and system resource utilization changes;
compare cached responses with updated data samples to detect inconsistencies or outdated information; and
correlate reported defects from issue tracking with specific cached APIs to identify relationships between caching and functional problems.

14. The system of claim 11, wherein the processor is further configured to:
rank the caching candidates based on information comprising at least one of consistency, access frequency, response time or payload size; and
perform the selection of each caching candidate based on the service of a respective API and the ranking.

15. The system of claim 11, wherein the processor is further configured to:
implement cache tagging and versioning mechanisms to facilitate selective invalidation when upstream data changes; and
establish a gradual rollout strategy starting with a threshold percentage of traffic directed to cached responses before full implementation of the selected caching implementations.

16. The system of claim 11, wherein the processor is further configured to:
maintain a reanalysis queue for APIs that experience caching-related issues;
subject APIs in the reanalysis queue to analysis to identify root causes of caching problems; and
re-enable caching with modified parameters for APIs that have been analyzed and remediated.

17. A non-transitory computer-readable storage medium tangibly encoded with computer-executable instructions, that when executed by a device, perform a method comprising:
identifying data associated with a set of sources, the data corresponding to behavior of an application program interface (API) associated with a respective source;
analyzing the data, and determining a set of caching candidates for each API;
analyzing the set of caching candidates, and determining, for each API, a selected caching candidate from the set of caching candidates, each selected caching candidate comprising functionality related to a service of a respective API; and
causing automatic configuration and execution of caching implementations for each API based on the selected caching candidate for each API.

18. The non-transitory computer-readable storage medium of claim 17, further comprising:
monitoring performance of the caching implementations for each API;
determining, based on the monitored performance, information related to an accuracy and appropriateness of each respective caching implementation; and
updating a caching implementation for a respective API when the determined information indicates an adaption to the caching implementation is required.

19. The non-transitory computer-readable storage medium of claim 17, further comprising:
ranking the caching candidates based on information comprising at least one of consistency, access frequency, response time or payload size; and
performing the selection of each caching candidate based on the service of a respective API and the ranking.

20. The non-transitory computer-readable storage medium of claim 17, further comprising:
maintaining a reanalysis queue for APIs that experience caching-related issues;
subjecting APIs in the reanalysis queue to analysis to identify root causes of caching problems; and
re-enabling caching with modified parameters for APIs that have been analyzed and remediated.
